(19) United States
(12) Patent Application Publication
(10) Pub. No.: US 2011/0309651 A1
(43) Pub. Date: Dec. 22, 2011

(54) Adjustable height horizontal lockable frame method to attach and to lift a truck bed cover

(76) Inventors: Jose Enrique Hernandez, Houston, TX (US); Jose Enrique Hernandez, JR., Houston, TX (US)

(21) Appl. No.: 13/134,399

(22) Filed: Jun. 7, 2011

Related U.S. Application Data
(60) Provisional application No. 61/356,638, filed on Jun. 20, 2010.

(51) Int. Cl. B60P 7/02

(52) U.S. Cl. 296/100.08

(57) ABSTRACT

An adjustable hold height lockable horizontal the two-piece member frame assembly method to attach and to lift a truck bed cover truck bed cover has a two-piece frame structure including front and rear frame members and front and rear cover panels secured thereon, the frame members hinged connected to move between a flat horizontal closed position covering the truck bed and an adjustable open position wherein the front frame and front panel is disposed adjacent to the truck cab and the rear frame and rear panel is disposed horizontally at selected hold heights above the bed, or extending angularly upward from the front frame and front panel. The cover can be adjusted and locked as option at selected hold positions between the closed and open positions. The two-piece frame and panel members where the rear frame has a elongate L-shape bracket attach onto inside interior of the front rear frame rail and where the top end of gas strut support assembly is attach onto and bottom end of gas strut support assembly with a locking device is attach to a bracket support that is attach on the truck bed inside corner which support rear cover and facilitate lifting and locking the rear cover in various positions also in the combination with on the rear cover a L-shaped bracket members attach to inside rear frame with selected longitudinally spaced holes which thereof can be adjusted to different length of rear cover which is attach to top end member of a tubular support member assembly and bottom end gas tubular support attached to back bracket support attached to the opposed inner sides of the truck bed and also the lockable slide rails assembly also link to a chain onto a tension springs provided a pull when attach to interior insides of the truck bed corner end which facilitate lifting and able to lock the rear cover in various positions. The front and rear cover panels may be made of a hard rigid material or a soft flexible heavyweight fabric material separately or the two piece frame assembly can be molded on to with fiberglass material or with other hard material separately.

### CROSS-REFERENCE TO RELATED APPLICATIONS

This application claims the benefit of provisional patent application No. 61/356,638, filed Jun. 20, 2010 by the present inventor.

### FEDERALLY SPONSORED RESEARCH

Not Applicable

### SEQUENCE LISTING OR PROGRAM

Not Applicable

### BACKGROUND

### Field

As used herein, the terms “truck bed cover” and “tonneau cover” refer to a hard or soft cover for a pickup truck bed. As used herein, the term “gas strut support” is a synonymous to a conventional gas strut lift, hydraulic gas cylinder, lift support, gas cylinder, and damper. Conventional hard truck bed covers and tonneau covers open by a hinging or folding mechanism while soft covers open by rolling up. Hard truck bed one and two section panel covers and tonneau covers are typically a solid rail rib, perimeter rail, mold segment or with a center frame support molded construction usually formed of fiberglass and typically opens from the tailgate end of the truck bed (back to front) similar to a clamshell. However, some are available that will one section open front to back, side to side, or even rise vertically or two sections horizontally. Conventional soft truck bed covers and tonneau covers are typically made of cloth or vinyl and usually require a rib-like structure to support the fabric and keep it taut while others may use a snap-based system. Many conventional soft truck bed covers and tonneau covers roll up or fold up toward the cab of the truck. Retractable hard and soft truck bed covers and tonneau covers are also known in the art, which are mounted at the front and sides of the bed and roll up or retract from the tailgate toward the cab.

One of the major problems with conventional one section or two section hard truck bed covers and tonneau covers that open from the tailgate end of the truck bed (back to front) similar to a clamshell is that because they are typically pivoted or raised angularly from the front end of the truck bed, access to the front area of the truck bed, and the ability to carry large items is severely limited. Often the hard truck bed cover or tonneau cover has to be removed in order to transport large items.

Other major problems with conventional one section or two section hard truck bed covers and hard tonneau covers are typically with a building a molded cover design surrounded by a rail rib support, heavy corrugated support panel, perimeter rail support, mold segment or a center frame support molded in construction usually formed of fiberglass material or with other hard material tended to be very heavy and expensive.

Conventional soft truck bed covers and tonneau covers also have this same problem. They must be rolled up or folded up toward the cab of the truck, thus access to the front area of the truck bed, and the ability to carry large items is severely limited. Often the entire soft tonneau cover or portions thereof have to be removed in order to transport large items.

There are several patents that are directed toward one section or two section truck bed covers and tonneau covers that that can be moved between a flat horizontal position covering the truck bed and an open position wherein the rear section is disposed horizontally a distance above the truck bed.

De Vries, U.S. Pat. No. 7,267,389, discloses a pickup truck bed two section cover that includes front and rear sections hinged together along contiguous edges and the front section other edge is hingedly connectable to a vehicle load bin (truck bed). The rear section carries a support pivoted at one end thereto with the other end pivotally mountable to the load bin to enable the cover to be raised and lowered with the rear section maintained in a substantially constant relation to the load bin (truck bed cover). The problems with this invention are that the side slides are to short which limit raising the rear cover to gain good access of the front to cargo and not easily to adjust to height or lock. Also very expensive cover two structure section covers to produce.

Lund et al, U.S. Pat. No. 5,988,728 discloses a single truck bed tonneau cover having a tapered one section pickup truck cover bed construction. The tonneau cover includes mounting side rail on one the driver side and a second on passenger side sidewall of a pickup truck bed; and a rigid panel for slideably mounting along the diver side rail and the passenger slide rail. The invention relates to a tonneau cover for a truck bed which slides rearwardly in order to open the forward position of the pickup truck, and which has an end which can move upwardly to further open and expose the pickup truck bed. The problems with this invention the raising the rear cover although this has a little more access to the front to cargo but is still limited and not easily to adjust to height or lock.

Hardy et al, U.S. Pat. No. 7,513,562, discloses an improved mechanism and method as an add-on frame structure for attaching a hard tonneau cover to a vehicle and to raise either just the rear of the cover or raise both the rear and front of the cover. The cover is supported in the raised position by two extending arms in the rear and by two rigid arms in the front. In operation, the rear of the cover is manually raised first and then the front of the cover can be manually raised. One embodiment has clamping telescoping arms for greater strength and to lock the cover in any position. Another embodiment has linear actuators to assist raising the front of the cover. The problem with this invention is that is add-on mechanism attachment device to already existing cover hard tonneau and also the installing method can get very expensive.

Thacker, U.S. Pat. No. 7,481,480, discloses a single piece section truck bed cover which is supported on legs pivotally mounted to the bed of the truck. In an open position the cover is raised and extends over the rear tailgate of the bed, and in a closed position, the cover encloses the bed. The invention utilizes a closing mechanism that enables the user to lower the cover from the raised position. This tonneau cover is a very heavy system mechanism requiring an electric-hydraulic motor is very expensive. Also a very top heavy truck cover on legs supports making it very unstable when locked in open raised position.

Mack et al, U.S. Pat. No. 6,820,915 discloses a convertible cover arrangement for vehicle cargo area which can function as both a tonneau cover and a cargo bed cap. The cover is raised by motorized elements to be substantially aligned with a roof of a passenger cabin of the vehicle. Side and rear window panels stored inside the cover can be installed to transform the cover to a cap to enlarge available enclosed cargo space. Rear pillars are installed at the rear corners of the tonneau cover in its raised position to complete the installation. This invention which may function as a tonneau truck bed cover and can be converted to a cargo box bed cover The problems with this invention is heavy and it has limit to the raising the rear cover to gain good access of the front to cargo which need to raised the cover by motorized elements and very expensive.

Hernandez et al, U.S. Pat. No. 6,572,174 discloses an articulating cover for the bed of a vehicle which includes a hinge connecting a first portion and a second portion and which can articulate as the cover is raised. The first portion has a front end pivotally mounted to a front wall of the bed, and the second portion has a forward end pivotally mounted to a second end of the first portion. A pair of front brackets is attached to the upper forward corners of the vehicle bed and a pair of rear brackets is attached to the upper right and upper left sides of the bed. A front pair of force spring assembly members is attached to the front brackets and first portion of the cover, and a rear pair of force spring assembly members are attached to the rear brackets and the second portion of the cover. The force spring assemblies apply a lifting force to assist in raising and supporting the first and second portions in an open position away from the truck bed and a closed position secured onto the bed. The problem with is two section panel invention is expensive, very mechanical and not very stable. Also has no variable locking open position and limited height to length of a front pair force spring assembly and a pair spring assembly of rear brackets is attached to the upper right and upper left sides of the bed.

### SUMMARY

The present invention is distinguished over the prior art in general, and these patents in particular by an adjustable hold height adjustable horizontal height lockable two piece member frame method to attach and to lift a truck bed cover which has a two-piece frame structure including front and rear frame members and front and rear cover panels secured thereon. The frame members are hingedly connected to move between a flat horizontal closed position covering the truck bed and an adjustable open position wherein the front frame and front panel is disposed adjacent to the truck cab and the rear frame and rear panel is disposed horizontally at selected heights above the bed, or extending angularly upward from the front frame and front panel. The cover can be adjusted and locked with an option to lock at selected positions between the closed and open positions. The two-piece frame and panel members are mounted on slide rails attached to the upper interior sides of the bed and provided with adjustable tension springs; pull chains, and with an option to lock lockable support slide bars device on to the gas strut support facilitate lifting and locking as an option to the cover in various positions. The front and rear cover panels may be made of a hard rigid material, or a soft flexible light or heavyweight fabric material or the two piece frame assembly can be molded onto frame with fiberglass material or with other hard material separately.

One of the significant feature and advantage of the present invention is that the two piece member frame method to attach to truck bed section panel cover members of various different types of materials can be installed on the frame components like rigid materials sheets, lighter corrugated support—or wood to provide a hard truck bed cover; such as lightweight metal, fiberglass, or wood, to provide a hard truck bed cover; or soft flexible light or heavyweight flexible materials or such as cloth, canvas, or vinyl, to provide a soft truck bed cover separately.

Another of the significant features and advantages of the present invention is that the two piece member frame method to attach to truck bed cover member frame assembly structure can be molded onto frame with fiberglass material or with other hard material separately.

Another of the significant features and advantages of the this present invention is that the two-piece member frame assembly method to attach and to lift a truck bed cover is easier to lifted lid cover than other to different open positions and hold with an option to lock at selected hold positions between the closed and open positions.

Another of the significant features and advantages of the present invention is that the two-piece member frame assembly method to attach and to lift a truck bed cover frame and panel members can be moved between a flat horizontal closed position completely covering the truck bed and an adjustable open position wherein the front frame and front panel is disposed adjacent to the truck cab and the rear frame and rear panel is disposed horizontally at selected heights above the bed, or extending angularly upward from the front frame and front panel.

Another feature and advantage of the present invention is that the two-piece member frame assembly method to attach and to lift a truck bed cover can be manually lifted easily and safely to an open position facilitated by adjustable tension springs and gas strut support.

Another feature and advantage of the present invention is that the adjustable tension springs and pull chain can be pre-set to control the ease of lifting and retaining the cover in various open positions, and with an option to lock with a lockable support slide bars device on to the lockable gas strut support allow the cover to be selectively locked to the cover in to secure it various open position and prevent it from collapsing while driving and during strong wind conditions.

Another feature and advantage of the present invention is a lockable gas strut support tubular add on elongate assembly to a gas strut of the present invention are somewhat similar to a conventional gas strut support typically used for supporting specially to a truck bed cover lid also known as lift supports, lift struts, lift shocks, gas cylinders, gas struts, and dampers but this an add-on main support member and rear member can archive greater height and adjustable to different height and option to lock and also can be use on to a hoods, tailgates, hatchback lid and trunks of an automobile.

Another feature and advantage of the present invention is that the front frame and panel section is hingedly connected to the front of the truck bed and to the rear frame and panel section to provide pivoting action at their juncture so as to allow the rear frame and panel section to be raised horizontally, and also angularly upward from the front frame and panel section to allow full access to the entire bed to facilitate loading and unloading of items anywhere in the bed.

Another feature and advantage of the present invention is that, when the cover is raised to the fully open position and locked, sufficient height is provided to allow an average sized person to stand in the truck bed and easily load, stack, organize, and unload items of various sizes.

Another feature and advantage of the present invention is that the components of the two-piece member frame assembly method to attach and to lift a truck bed cover can easily and quickly installed, assembled, disassembled, and removed in sections by one person.

Another feature and advantage of the present invention is that the front frame and panel section and the rear frame and panel section are separable so that they can be easily stored, and the components can be packaged and shipped in a relatively small package or container compared to a larger single-piece cover.

A further feature and advantage of this invention is that the two-piece member frame assembly method to attach and to lift a truck bed cover rear frame and panel section can be raised to a selected height horizontally above the truck bed to form a raised roof over the bed and fabric panels can be extended from sides and end of the rear frame and panel section to form a tent structure.

A still further feature and advantage of the present invention is that the two-piece member frame assembly method to attach and to lift a truck bed cover adjustable height and hold horizontal lift truck bed frame method to attach and to lift truck bed cover is simple in two piece constructions, inexpensive to manufacture, shipping and rugged and reliable in operation.

Other features and advantages of the two-piece member frame assembly method to attach and to lift a truck bed cover invention will become apparent from time to time throughout the specification and claims as hereinafter related.

### DRAWINGS—FIGURES

FIG. 1 is a perspective view of the rear portion of a pickup truck bed showing the adjustable height horizontal lift truck bed cover in accordance with the present invention installed therein in a partially open position.

FIG. 2 is a side elevation of the rear portion of a pickup truck bed illustrating the front and rear hinged frame and panel members of the adjustable height horizontal lift truck bed cover in various positions between the closed position and fully opened position.

FIG. 3 is a perspective view showing the front and rear hinged frame and panel members of the adjustable height horizontal lift truck bed cover in the closed position.

FIG. 4 is a perspective view showing the front and rear hinged frame and panel members of the adjustable height horizontal lift truck bed cover in the fully opened position.

FIG. 5 is a side elevation of the inside of a side wall of the truck bed showing the slide rail, support bar, gas strut assembly, tension spring, pull chain, and bracket members of one side of the adjustable height horizontal lift truck bed cover, with the front and rear hinged frame and panel members in the closed position.

FIG. 6 is a partial side elevation view of the hinged connection between the front and rear frame and panel members of the adjustable height horizontal lift truck bed cover, with the front and rear hinged frame and panel members shown in the closed position.

FIG. 7 is a partial side elevation view of the hinged connection between the front and rear frame and panel members of the adjustable height horizontal lift truck bed cover, with the front and rear hinged frame and panel members shown in the one of the opened position.

FIG. 8 is a side elevation of the inside of a side wall of the truck bed showing the slide rail, support bar, gas strut support assembly, tension spring, pull chain, and bracket members of one side of the adjustable height horizontal lift truck bed cover, with the front and rear hinged frame and panel members in a partially open position.

FIG. 9 is an exploded perspective view showing the components of the front and rear frame sections and hinge connections in an unassembled condition.

FIGS. 10 and 11 are a bottom plan view and a top plan view, respectively, of the components of the front and rear frame sections and hinge connections in an assembled condition.

FIGS. 12 and 13 are a side elevation and a top plan view, respectively, showing the slide rail and slider bolts locking device to slide rail bracket support assembly, support bar, tension spring, pull chain, and bracket members of one side of the adjustable height horizontal lift truck bed cover in greater detail.

FIG. 14 is a partial perspective view showing the tubular C shape slide rail mounted to the top rail of one side wall of the truck bed in greater detail.

FIG. 15 is top plan view side of a molding strip that can be installed on the opposed sides of the front and rear frame assemblies and on the rear side of the rear frame assembly.

FIG. 16 is a partial cross sectional view showing the key lock assembly for locking the rear frame assembly to the truck bed truck tailgate and a molding strip at the side of the rear frame assembly in greater detail.

FIG. 17 is a perspective view showing the front and rear frame and panel members of the adjustable height horizontal lift truck bed cover in the open position with fabric panels extending from the rear frame and panel member to form a tent structure.

FIG. 18 is an exploded perspective views showing a gas strut inside the support tubular add-on elongate two member assembly, slide bar lockable device and clamping collar.

### DETAILED DESCRIPTION

As used herein, the term “truck bed cover” is synonymous with the term “tonneau cover”, and means a hard or soft cover for a pickup truck bed. For ease of discussion the present invention will be described throughout the description as a “truck bed cover” or “bed cover”. As used herein, unless otherwise specified, the term the term “panel” means a flat, generally rectangular piece of material which may be a hard or rigid material or a soft flexible material. For purposes of example only, and not limited thereto, the “panels” depicted in the drawings are illustrated as flat, generally rectangular pieces of a hard or rigid material. In the following discussion, unless otherwise specified the term “front” refers to the direction facing the cab of the pickup truck and the term “rear” refers to the direction facing away from the cab or toward the tailgate of the pickup truck. The terms “left” and “right” refer to the respective sides of the truck bed cover or the truck bed when looking from the rear toward the cab of the pickup truck.

The terms “outer” and “outward” refer to the direction which is away from the interior of the bed of the pickup truck, and the terms “inner” and “inward” refer to the direction toward the interior of the bed of the pickup truck.

The term “gas strut support”, as used herein, means a fluid or gas-charged cylinder of the type typically used for supporting truck bed cover lid, hoods, tailgates, hatchbacks and trunks of an automobile, also known as lift supports, lift struts, gas cylinders, gas struts, and dampers.

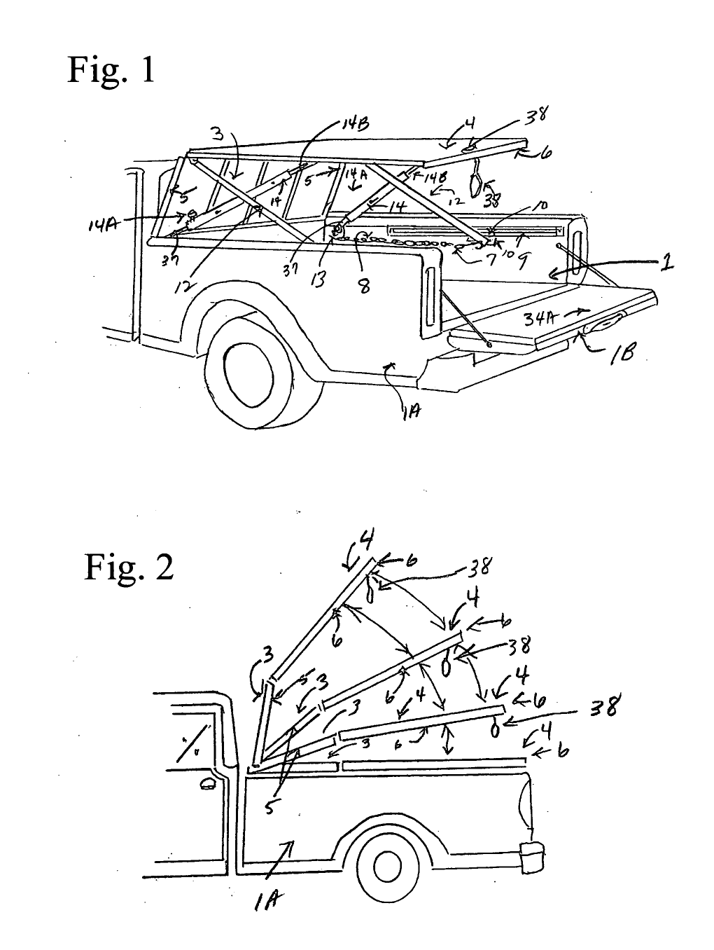

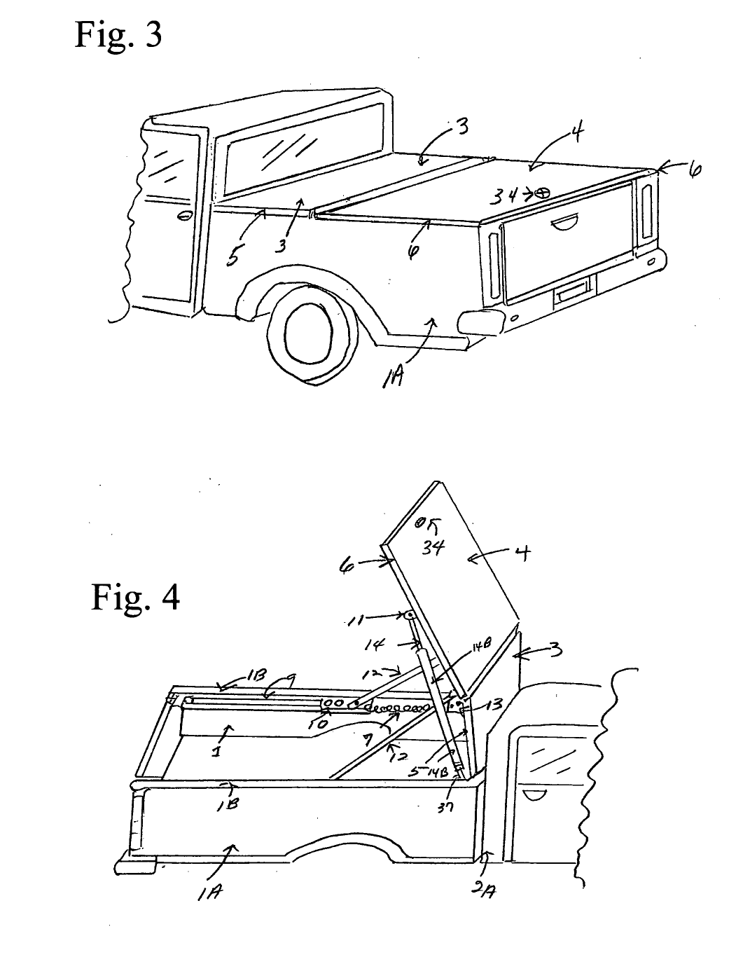

As discussed briefly above, the present invention of the two-piece member frame assembly method to attach and to lift a truck bed cover is directed toward an adjustable height hold horizontal lift truck bed cover which has a two-piece frame structure including front and rear frame members and front and rear cover panels secured thereon. Referring now to the drawings by numerals of reference, FIGS. 1, 2, 3, and 4 show the front and rear panels 3 and 4 attached to the front and rear frame members 5 and 6 of the bed cover in various open and raised positions and the closed position.

As seen in FIGS. 1, 4, 5 and 8, the typical pickup truck bed has left and right outer side walls 1A and opposed inner sides 1, a top rail 2B formed along the top end of the side walls which typically has a short down-turned lip facing the interior of the bed, and a tailgate 1B pivotally mounted at the rear end of the bed. An elongate slide rail 9 and sliding bracket assembly 10 are attached to each of the short down-turned lips of the top rails 1B near the top of the opposed inner sides 1 of the truck bed, as described in greater detail hereinafter. A pair of front brackets 13 are attached to the opposed inner sides 1 of the truck bed forward of the slide rail 9 near the front corners of the vehicle bed. A pair of flat bar members 12 are each pivotally attached at one end to a respective sliding bracket assembly 10 and their opposed end is pivotally attached to a respective angle bracket 11 secured to the front portion of the rear frame 6 near its outer sides (described hereinafter). A pair of lockable gas strut support members 14 having a thumb screw locking member 14A near one end are each pivotally attached at one end to a respective bracket 13 near the front corners of the vehicle bed and their opposed end is pivotally attached to a respective left and right framing member of the rear frame member 6 (described hereinafter). A pair of tension springs 7 is each attached at one to a respective sliding bracket assembly 10 and their opposed end is attached to one end of a respective length of a pull chain 8. The opposed end of each pull chain 8 is attached to a respective bracket 13 near the front corners of the vehicle bed. At least one flexible pull strap 37 is secured at one end to the rear portion of the rear frame 6 and has a hand loop at its free end to aid in manually lowering the cover from an elevated open position to a closed position. A key lock member 34 is secured to the rear portion of the rear panel 4 and releasable engages a lock bracket 34A mounted on the inside tailgate 1B in the closed position (described hereinafter).

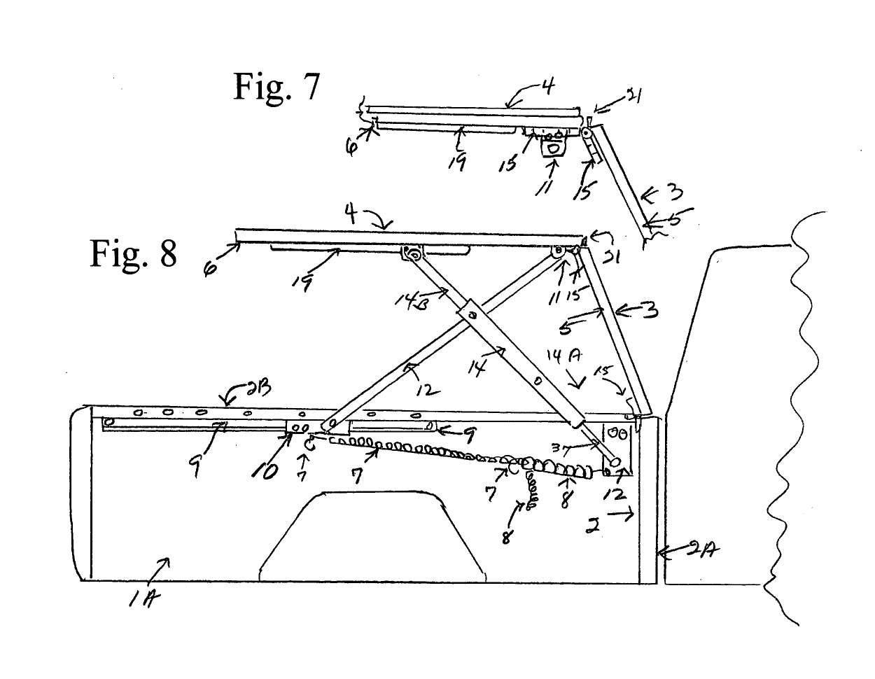

As seen in FIGS. 6 and 7 an elongate seal element 21 is secured either to the rear face of the rear tubular member 5B of the front frame 5 or the front face of the front tubular member 6A of the rear frame 6 to form a weather tight seal there between when the front and rear frame members 5 and 6 are in the horizontal closed position. An elongate seal element 21 is also secured to the underside of the front, rear and side tubular members 5A, 5B, 5C of the front frame 5 and the front, rear and side tubular members 6A, 6B, 6C of the rear frame 6 to form a weather tight seal between the underside of the cover and the top rail of the truck bed side walls, front wall, and top surface of the tailgate in the horizontal closed position.

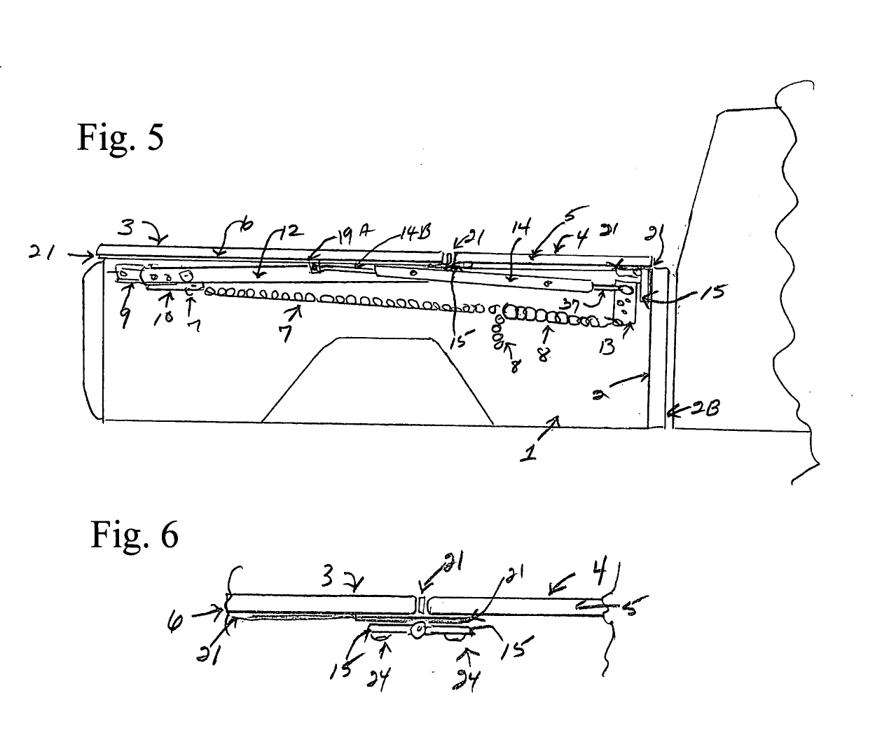

As seen in FIGS. 5 and 8, an elongate seal element 21 is secured either to the rear face of the rear tubular member 5B of the front frame 5 or the front face of the front tubular member 6A of the rear frame 6 to form a weather tight seal there between when the front and rear frame members 5 and 6 are in the horizontal closed position. An elongate seal element 21 is also secured to the underside of the front, rear and side tubular members 5A, 5B, 5C of the front frame 5 and the front, rear and side tubular members 6A, 6B, 6C of the rear frame 6 to form a weather tight seal between the underside of the cover and the top rail of the truck bed side walls, front wall, and top surface of the tailgate in the horizontal open position. Also FIG. 8 shows the gas strut assembly 14 can be locked as an option by tightening the thumb screw 14A.

The adjustability and locking operation consist of a the tension of the tension spring 7 can be preset to control the ease of lifting and retaining the cover in various open positions by attaching the opposed end of the spring to a selected link at the free end the pull chain 8. This adjusts the effective length of the chain 8 to be shorter or longer and, thus the distance between the anchors points of the spring (sliding bracket member 10) and the chain (stationary bracket 13). The tension in the spring 7 provides a forward pulling force to the sliding bracket 13 when the cover is being raised (opened), to reduce the manual force required, and provides a resistance force to the rearward movement (toward the tailgate) of the sliding bracket member 10 when the cover is being lowered (closed), to prevent it from closing too quickly or slamming closed due to gravity. The tension in the spring 7 also allows the cover to be easily manually positioned at various positions.

Additionally, the gas charged lift supports 14 connected between the truck bed and the rear frame 6 control the rate at which the cover is raised (opened) and lowered (closed), reduces the manual force required, and prevent it from closing too quickly or slamming closed due to gravity. The effective length between the anchor points of the gas strut tubular rear support assembly 14B can be adjusted to different length of rear cover 4 by attaching the upper ends thereof at selected longitudinally spaced holes 19A in the vertical legs of the L-shaped cross members 19 of the rear frame 6.

Thus, the frames 5, 6 and panels 3, 4 members can be easily moved between a flat horizontal closed position completely covering the truck bed and an adjustable open position wherein the front frame 5 and front panel 3 is disposed adjacent to the truck cab and the rear frame 6 and rear panel 4 is disposed horizontally at selected heights above the bed, or extending angularly upward from the front frame 5 and front panel 3, and can be easily locked 14A and secured in various open positions to prevent it from collapsing, for example while driving and during strong wind conditions.

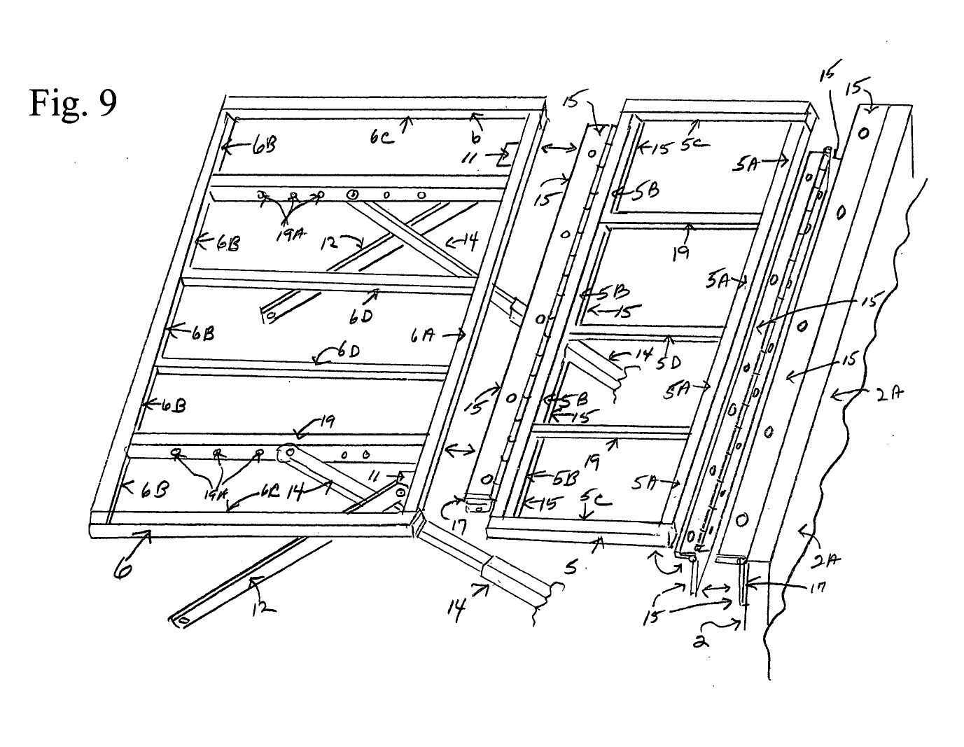

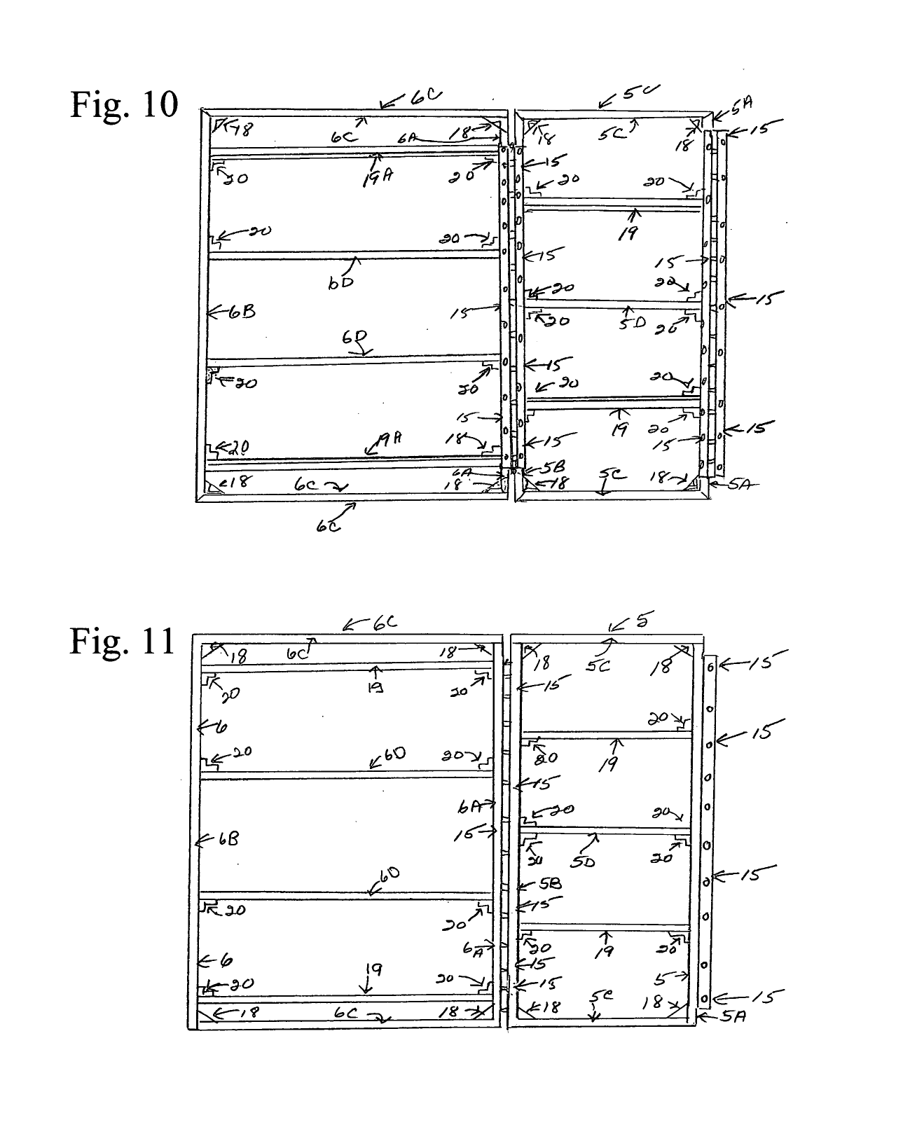

The frame assembly FIGS. 9, 10 and 11 shows the two-piece frame structure in greater detail with the front and rear panels 3 and 4 removed to more clearly show the frame members. The front frame member 5 and rear frame member 6 are separate structures formed of tubular tubing adjoined by an elongate hinge. The front frame member 5 is a generally rectangular configuration formed by front and rear tubular members 5A and 5B, left and right tubular side members 5C welded thereto. A central tubular cross member 5D, and two and two L-shaped angle cross members 19 laterally spaced therefore are secured between the front and rear tubular members 5A and 5B in parallel spaced relation. Corner braces 18 are welded to the inner corners of the front and rear tubular members 5A, 5B and left and right tubular side members, and angle brackets 20 are welded to the intersections of the tubular cross member 5D and angle cross members 19 and front and rear tubular members for extra support. An elongate front hinge 15 is provided on the front tubular member 5A of the front frame 5. One leaf of the front hinge 15 is secured to the underside of the front tubular member 5A and the other leaf of the front hinge is secured to the inside surface 2 of the front wall 2A of the truck bed. Preferably, the leaves of the front hinge 15 are removably secured by screws so that the front frame 5 can be removed from the front wall 2A of the truck bed when desired. Alternatively, the front hinge 15 may be provided with a removable hinge pin so that the front frame can be removed from the front wall of the truck bed when desired.

The rear frame member 6 is a generally rectangular configuration formed by front and rear tubular members 6A and 6B, left and right tubular side members 6C welded thereto. Two laterally spaced tubular cross members 6D are secured to the front and rear tubular 6A, 6B members in parallel spaced relation. Two L-shaped angle cross members 19 laterally spaced outwardly from the cross members 6D are secured between the front and rear tubular members 6A and 6B in parallel spaced relation.

Corner braces 18 are welded to the inner corners of the front and rear tubular members 6A, 6B and left and right tubular side members 6C, and angle brackets 20 are welded to the intersections of the tubular cross member 6D and angle cross members 19 and front and rear tubular members 6A, 6B for extra support.

An elongate connector hinge 15 is provided between the front frame member 5 and rear frame member 6. One leaf of the hinge 15 is secured to the underside of the front tubular member 6A of the rear frame 6 and the other leaf of the hinge is secured to the underside or the rear tubular member 5B of the front frame 5. Preferably, the leaves of the connector hinge 15 are removably secured by screws 24 so that the rear frame 6 can be disconnected and removed from the front frame 5 when desired. Alternatively, the connector hinge 15 may be provided with a removable hinge pin so that the rear frame 6 can be disconnected and removed from the front frame 5 when desired.

The vertical leg of each of the two L-shaped angle cross members 19 laterally spaced outwardly from the cross members 6D of the rear frame 6 are provided with a series of longitudinally spaced adjustment holes 19A. The upper end of each gas strut assembly rear member 14B is pivotally connected to selected adjustment holes 19A, and its lower end is pivotally attached to a respective bracket 13 on the inner side 1 of the truck bed near the front corners of the bed, as described above.

A pair of angle brackets 11 are each secured to the rear surface of the front tubular member 6A of the rear frame 6 near its outer ends. The top end of a respective flat bar member 12 is pivotally attached to a respective angle bracket 11, and its lower end is pivotally attached to a respective sliding bracket plate 10 of the elongate slide rail 9 mounted on the side of the vehicle bed.

In the lockable gas strut support tubular add on elongate assembly 14, 14B to a gas strut 37 of the present invention are somewhat similar to a conventional gas strut support typically used for supporting specially to a truck bed cover lid also known as lift supports, lift struts, lift shocks, gas cylinders, gas struts, and dampers but this an add-on main support member 14 and rear member 14B can archive greater height and adjustable to different height and option to lock and also can be use on to a hoods, tailgates, hatchback lid and trunks of an automobile. As well known in the art, a conventional gas-charged lift support has a fluid filled cylinder which houses a piston assembly with valves that allows the fluid to pass through the piston to provide controlled extension and retraction of a piston rod the extends outwardly of the cylinder. The cylinder has an adapter eye end or adapter socket end device at one end which is mounted to a first support and the piston rod has an adapter eye or adapter socket end device at its bottom end which is mounted to a second support.

In the gas strut support 14, 14B of the present invention, the fluid-filled cylinder is mounted within a tubular housing 14, the upper end of which has a flat extension with a hole there through pivotally connected to a selected adjustment hole 19A in the vertical leg of the L shaped cross member 19 of the rear frame 6, and the eye at the end of the piston rod is pivotally to the bracket 13 on the inner side 1 of the truck bed, as described above. A flat rectangular bar 40 having a plurality of longitudinally spaced holes there through is secured to the piston rod 37 with a U clamp 51 to move therewith relative to the tubular housing. The lower end of the tubular housing is provided with a thumb device 14A screw 49, nut 48 which is engageable with a selected hole 50 in the rectangular strap 40 to lock or releasable lock the piston rod 39 at a selected extended or retracted distance, and thereby prevent movement in both directions (extension and retraction).

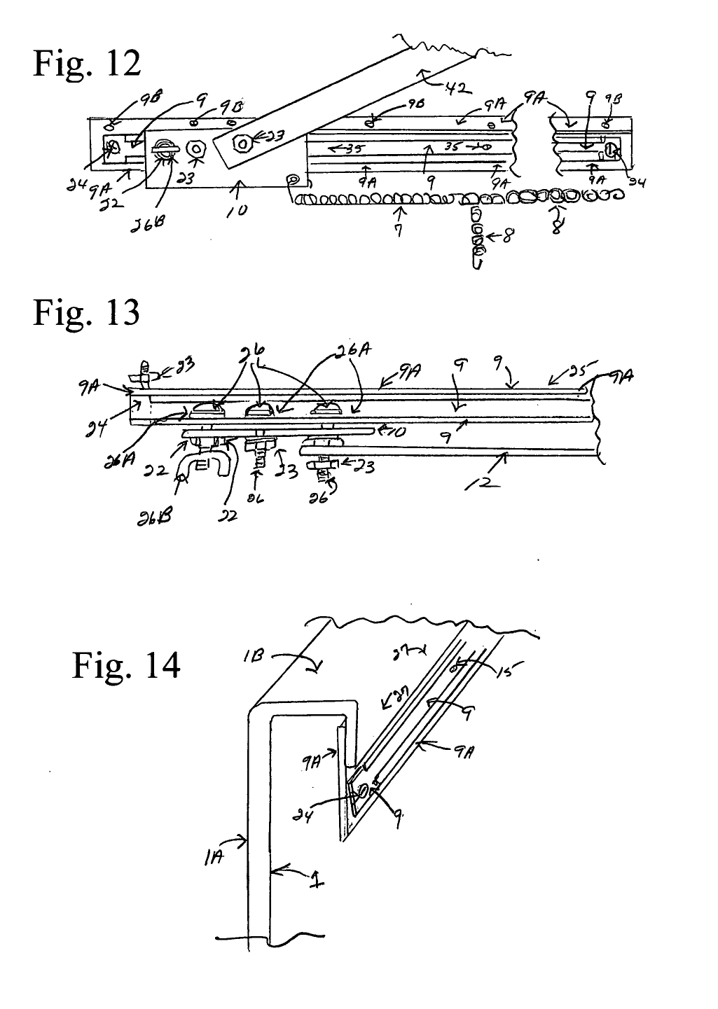

FIGS. 12, 13, and 14 show the mounting arrangement of the elongate slide rails 9 and sliding, locking member bracket assembly 10 in greater detail. Each slide rail 9 is an elongate channel having a generally square C-shaped cross section with up-turned lips which is secured along its length to an elongate flat rectangular back plate 9A by rivets 25, and by bolts 24 and nuts 23 at each end. The upper longitudinal side of the back plate 9A is secured to the backside of the short down-turned lip of the top rail 1B of the opposed inner sides 1 of the truck bed by screws 27 or other suitable fasteners. The heads of three round head bolts 26 are slidably received and retained within the up-turned lips of the slide rail channel 9 with their shanks facing outwardly from the slide rail 9. The sliding bracket member 10 is a flat rectangular plate having several longitudinally spaced holes there through that are received on the outwardly extending shanks of the round head bolts 26. One end of a respective flat bar member 12 is provided with a hole which is slidably received on the shank of the forward-most round head bolt 26 and secured by a nut 23 with a washer installed between the sliding bracket 10 and the flat bar 12. A washer and a hex nut 23 are installed on the shank of the intermediate round head bolt 26. A washer and a wing lock nut 22 are installed on the shank of the rear-most round head bolt 26. The lower longitudinal side of the sliding bracket member 10 extends below the slide rail 9 and back plate 9A and is provided with a hole near its forward corner in which the end of a respective tension spring 7 is mounted. As discussed above, the opposed end of each spring 7 is attached to a link at the free end of a respective length of a pull chain 8 which is attached to a respective bracket 13 near the front corners of the vehicle bed.

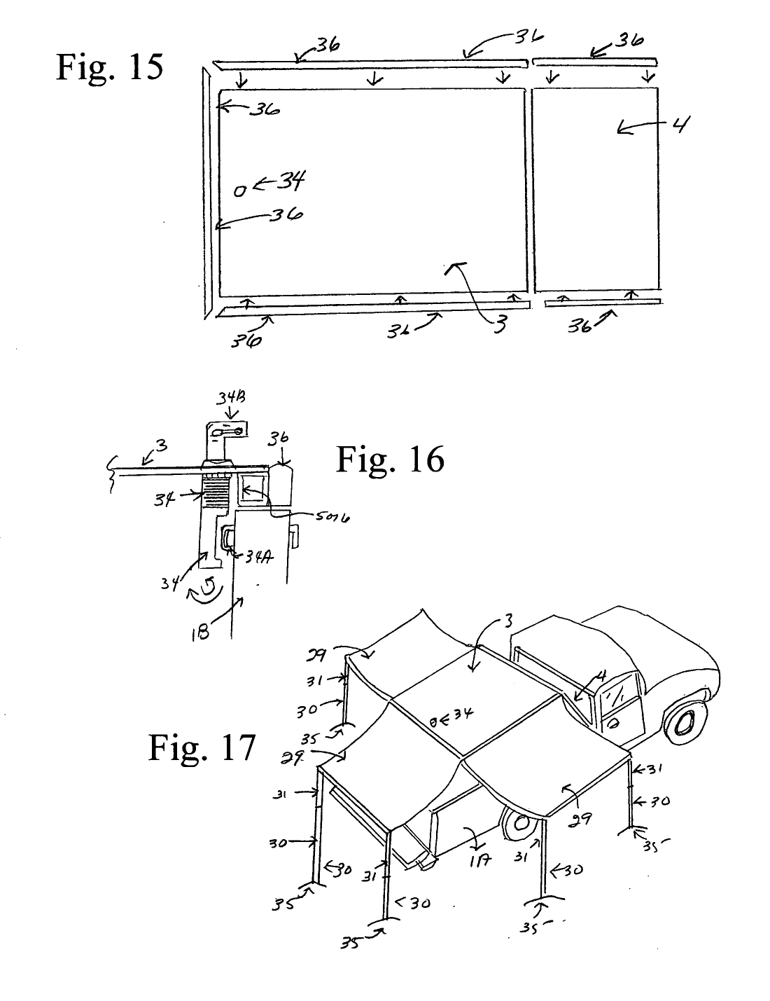

As shown in FIGS. 15 and 16, elongate quarter round molding strips 36 may also be installed on the outer face of the front, rear and side tubular members 5A, 5B, 5C of the front frame 5 and the front, rear and side tubular members 6A, 6B, 6C of the rear frame 6 to provide an attractive smooth rounded surface on the perimeter of the front and rear cover panels and frame members.

FIG. 16 also shows the key lock member 34 in greater detail. The key lock member 34 is similar to a conventional cylindrical key lock having a barrel portion secured to the rear portion of the rear panel 3 with a keyway that removably receives a key 34B, but has an extended generally L-shaped tang element which is rotated by the key to releasable engage a lock bracket 34A mounted on the inward facing wall of the tailgate 1C in the closed position for locking the rear frame assembly 6 to the truck bed truck tailgate.

As shown in FIG. 15 The front and rear cover panels 3 and 4 depicted in the drawings are illustrated as flat, generally rectangular pieces of a hard or rigid material for purposes of example only, and not limited thereto. It should be understood that the front and rear cover panels 3 and 4 may be made of a hard rigid material or a soft flexible heavyweight fabric material or the two piece frame assembly can be molded with fiberglass material onto or with other hard material separately.

The front and rear cover panels 3 and 4 are secured to the top surfaces of the tubular members of the front and rear frame members 5 and 6, by conventional securing means. For example, in the case of panels formed of hard or rigid material, the panels may be secured by glue, epoxy, screws, or welding, depending upon the particular material used, and painted. In the case of panels formed of soft flexible heavyweight fabric material, the panels may be secured to the tubular frame members by glue or epoxy, and may also be painted depending upon the particular material used.

Tent accessory FIG. 17 shows the front and rear frame 5, 6 and panel members 3, 4 of the adjustable height horizontal lift truck bed cover in an open lock position with fabric panels 29 extending outwardly from the lateral and rear sides of the rear panel member 3 to form a tent structure. The outer ends of the fabric panels 29 are supported at their corners by conventional canopy poles 30 which may include an adjustable retractable upper extension 31 and have a bottom end adapted to be anchored in the ground 35 in a conventional manner.

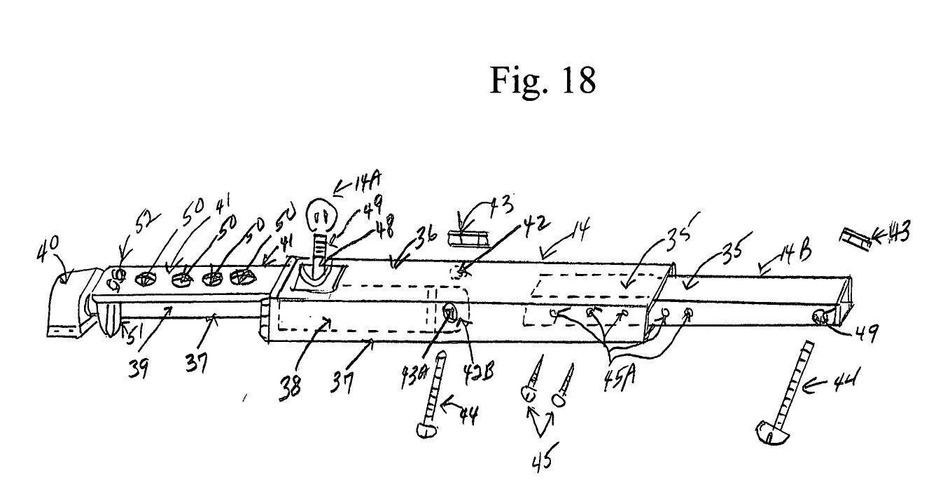

As shown in FIG. 18 showed an exploded view of the lockable gas strut add on elongate support assembly two member 14, 14B and components that consist of: a tubular front main member 36 and rear member 35 in length. A thumb turn bolt screw 49 locking device 14A that has an anchor nut 48 attach on the top front end tubular member 36. On the rear end of main tubular support 14 member 35 a small rear tubular front end of support 14B tubular member 35 in length which part of is in length inside of the main tubular support 14 member 36 and rear tubular member 35 extended in length outward which has on the end a eye hole 47 for bolt 44 and nut 48 which is use to attach to a main support 14. Also shows screws 45 screw on thru two holes 45 holes 46 on the rear tubular member 14B to adjust to different length needed to a first support. The front flat bar locking device 40 with a plurality of holes 50 on member flat bar 41 is attach on top front end of gas rod 39 with u-bolt clamp device 51 and the rear of flat bar 40 slides between front end of gas cylinder 38 and inside front main member 36 with a locking thumb screw 49, nut 48 device 14A is attach on the top main member 14 and used as a option to lock flat bar device 41.

While the present invention has been disclosed in various preferred forms, the specific embodiments thereof as disclosed and illustrated herein are considered as illustrative only of the principles of the invention and are not to be considered in a limiting sense in interpreting the claims. The claims are intended to include all novel and non-obvious combinations and sub combinations of the various elements, features, functions, and/or properties disclosed herein. Variations in size, materials, shape, form, function and manner of operation, assembly and use, are deemed readily apparent and obvious to one skilled in the art from this disclosure, and all equivalent relationships to those illustrated in the drawings and described in the specification are intended to be encompassed in the following claims defining the present invention.

### REFERENCES CITED

### U.S. Patent Documents

| | | | |
|---|---|---|---|
| 7,267,389 B2 | Sep. 11, 2007 | Kaiser | 296/100-07 |
| 6,447,045 | July 2000 | Dickson et al. | |
| 6,217,102 B1 | April 2001 | Lathers | 296/100.07 |
| 6,371,231 B1 | April 2002 | Nushil et al. | 180/69.21 |
| 3,155,423 A | November 1964 | Cripe | 296/100.08 |
| 5,002,329 A | March 1991 | Rafi-Zadch | 296/100.08 |
| 3,640,073 A | March 1972 | Whittemore | 296/100.08 |
| 5,366,266 A | November 1994 | Harbison | 296/100.02 |
| 5,951,095 A | September 1999 | Herndon | 296/165 |

I claim:

1. An adjustable hold height horizontal lockable frame method and lift to attach to a two-piece truck bed covers, comprising;
a front frame method section having a forward end for pivotal mounting with respect to a front wall of a vehicle bed, and rearward end;
a rear frame method section having a forward end hinged connected with said rearward end of said front cover section for pivotal movement relative thereto, and having a rearward end;
a pair of longitudinal slide rails lift method assembly for attachment each to an upper portion of respective opposed sides of said vehicle bed, and a lockable slide bracket slidably mounted in each said slide rail for longitudinal movement there along;
a pair of front bed brackets for lift method attachment to the upper portion of respective opposed sides of said vehicle bed forward of said slide rails assembly;
a first pair of rear cover brackets lift method each attached to said forward end of said rear cover section adjacent to respective opposed sides of said rear cover section;
a pair of support arms each pivotally connected at a first end with a respective said slide rail lift method lockable assembly bracket and at a second end with a respective said one of said rear cover brackets;
a pair of adjustable spring in length tension means each disposed between a respective said slide rail lift method lockable assembly bracket and a said front bed bracket for controlling longitudinal movement of said slide brackets;
a second pair of rear cover brackets lift method each attached adjacent to respective opposed sides of said rear cover section rearward of said first pair of rear cover brackets a pair of lockable gas strut support assembly each pivotally connected at a first end with a respective one of said front bed brackets and at a second end with a respective one of said second pair of rear cover brackets so as to control the rate at which said rear cover section and said front cover section are pivoted, raised and lowered between a closed position and an open position;
a pair of lockable gas strut add on to elongate support lift method assembly and adjustable to length to said rear frame cover can archive greater height in raising it to open position and lockable;
a second pair of rear cover brackets elongate L-shaped bracket members attach to inside rear frame with selected longitudinally spaced holes which thereof can be adjusted to different length of rear cover which is lift method attach to top end member of a tubular support member assembly and bottom end gas tubular support attached to back bracket support attached to the opposed inner sides of the truck bed;
said adjustable spring in length tension means lift method imparting a forward force on said slide, brackets, and upon forward movement thereof;
said support arms lift method imparting an upward force to said forward end of said rear cover section and said rearward end of said front cover section to assist in pivoting and raising said rear cover section and said front cover section to an open position;
said adjustable spring in length tension means lift method imparting a resistive tension force on said slide brackets upon rearward movement sufficient to assist in slowly lowering said forward end of said rear cover section and said rearward end of said front cover section to a closed position.

2. The adjustable height horizontal lockable frame method and lift to attach to two-piece truck bed covers according to claim 1, wherein;
each said lockable slide rail support assembly is capable of being locked to a respective said slide rail to prevent longitudinal movement there along to secure said front frame section at selected angular open positions relative to said front wall of said vehicle bed; and
each said lockable gas strut gas add on to elongate support assembly is capable of being locked as an option at respective extended and retracted positions to secure said rear frame section at selected angular open positions relative to said front cover section and said vehicle bed.

3. The adjustable height horizontal lockable frame method and lift to attach to two-piece truck bed covers according to claim 1, wherein;
said front frame panel section comprises a generally rectangular front frame method assembly and a front cover panel secured thereto;
said rear frame panel section comprises a generally rectangular rear frame method assembly and a front cover panel secured thereto; and
said front frame cover panel and said rear frame cover panel are formed of materials selected from the group consisting of generally rectangular rigid material and flexible fabric material;
said front frames and said rear frame can be molded with fiberglass material onto or with other hard material separately.

4. The adjustable hold height horizontal frame method lockable lift method to attach to two-piece truck bed covers according to claim 1, further comprising:
two lockable gas strut add on to elongate support member means is capable of archive greater height and adjustable to different height and option to lock and also can be use on to a truck bed cover lid, hoods, tailgates, hatchback lid and trunks of an automobile; and
two lockable slide rail support assembly means the ability of numerous hold open height positions with option to safe lock at any hold positions of a truck bed cover lid, hoods, tailgates, hatchback lid and trunks of an automobile and especially also be able to drive vehicle with the lid in the open position or associated method when safe lock is used.

5. The adjustable height hold horizontal lockable frame method and lift to attach to two-piece truck bed covers according to claim 1, further comprising:
two L-shaped bracket members attach to inside rear frame selected longitudinally spaced holes means the ability to adjusted to different length of rear frame cover that attach to the end of adjustable support member assembly and other end that attach to of the truck inside bed.

6. The adjustable hold height horizontal lockable frame method and lift to attach to two-piece truck bed covers according to claim 1, further comprising:
two adjustable springs in length tension means lift method to different open hold positions and imparting a resistive tension force on said slide brackets upon rearward movement sufficient to assist in slowly lowering said forward end of said rear cover section and said rearward end of said front cover section to a closed position.

7. The adjustable hold height horizontal lockable frame method and lift to attach to two-piece truck bed covers according to claim 1, further comprising:
two-piece member front and rear frame assembly construction separately a first method and a second method to cover panel members mean is easier to attach with different various types of lighter and thinner hard materials said panels frame cover.

8. The adjustable hold height horizontal lockable frame method and lift to attach to two-piece truck bed covers according to claim 1, further comprising:
two-piece member front and rear frame assembly construction and lift to attach to two-piece truck bed covers separately a first method and a second method to cover panel members means is easier to attach with different various types of flexible materials and third jointing said panels frame cover.

9. The adjustable hold height horizontal lockable frame method and lift to attach to two-piece truck bed covers according to claim 1, 8, further comprising:
two-piece member front and rear frame assembly and lift to attach to two-piece truck bed covers construction separately a first method and a second method to cover panel members means is easier to attach with different various types of flexible materials and third jointing and also mean frame cover material doesn't need to be removed to lift said panels cover.

10. The adjustable hold height horizontal lockable frame method and lift to attach to two-piece truck bed covers according to claim 1, 7, 8, further comprising:
two-piece member front and rear frame assembly lift to attach to two-piece truck bed covers construction separately a first method and a second method to cover panel members means is lighter to lift than other truck bed covers.

11. The adjustable hold height horizontal lockable frame method and lift to attach to two-piece truck bed covers according to claim 1, further comprising:
weatherproof resistant seal means disposed between said front and rear cover sections and a top surface of said vehicle bed.

12. The adjustable hold height horizontal lockable frame method and lift to attach to two-piece truck bed covers according to claim 1, further comprising:
lock means on said rear cover section selectively engageable with a closed tailgate of said vehicle bed for releasable securing said front cover section and said rear cover section in a horizontal closed position covering said vehicle bed.
